(19) United States
(12) Patent Application Publication
(10) Pub. No.: US 2026/0189630 A1
(43) Pub. Date: Jul. 2, 2026

(54) MULTI-MODAL AGENT

(71) Applicant: Wells Fargo Bank, N.A., San Francisco, CA (US)

(72) Inventors: Eric-Andre Vigroux, New Rochelle, NY (US); Deepak William Elias, Wilton, CT (US); Steven A. Jolley, Chester, SC (US); Vito A. Marchiano, Staten Island, NY (US); Maximilan Fuchs, Charlotte, NC (US); Ravi Kumar Sarvepalli, Matthews, NC (US); Benjamin S. Taylor, Williston, VT (US)

(21) Appl. No.: 19/007,521

(22) Filed: Jan. 1, 2025

(51) Int. Cl. H04L 67/148; G06F 3/0484

(52) U.S. Cl. CPC H04L 67/148; G06F 3/0484

(57) ABSTRACT

Systems and techniques to implement a multi-model agent are described herein. When a request corresponding to a session and having a context is received from a user, a large language model (LLM) can be invoked on the request and the context to produce a sequence of actions to complete the request. A first action from a set of available actions cab be selected as a next action along with a first user device from a plurality of user devices to complete the next action. If an indication that the first user device is not available is received, a second action can be selected for the next action on the indication, the request, or the context. A second device can be selected based on the second action and an interface on the second device can be invoked to perform the second action as the next action.

### BACKGROUND

Communications channels represent physical or procedural media though which information is transmitted from between parties (e.g., devices). Communications channels can be implemented in different ways, such as electrical signals, optical signals (e.g., in a fiber optic cable), photonic signals (e.g., light or radio spectrum), sound waves, etc. Typically, in digital communications, the channel carries waves or symbols that represent data in binary form, while in analog communications, data is generally transmitted as continuous signals. Communications channels are often subject to various constraints, such as bandwidth, noise, or interference. These constraints can affect the accuracy or reliability of the transmitted information. The effectiveness of a communication system depends on the characteristics of the communication channel used.

User devices used to participate in communications are hardware systems designed to send, receive, or process information across various channels. These devices include mobile devices (e.g., smartphones, mobile phones, tablets, etc.), computers, routers, or other communication tools. Each device contains components for encoding, decoding, and transmitting data through wired or wireless connections, using protocols to manage the flow of information and interact with networks. Typically, a user can use a smartphone for voice calls, text messaging, or video conferencing by interacting with touchscreens, microphones, and cameras to input and receive data. Similarly, a user can conveniently use a computer for email communication or file transfers, using a keyboard and mouse for input and an internet connection for transmitting data. In use, a tablet (or other device with a touchscreen) is practical to “sign” documents, provide drawings or sketches, or otherwise provide an alternative to paper for a variety of tasks. While each of these functions can be implemented in almost any of these devices, the form factor and likely user interface elements tend to make one device more useful, or practical, over another device depending upon the task.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 illustrates an environment including a system to implement a multi-modal agent, according to various embodiments.

FIG. 2 illustrates an example of a technique for selecting a user device from a plurality of user devices based on a first action and the context, according to various embodiments.

FIG. 3 illustrates a flowchart showing a technique for dynamically selecting a user device to execute an action from a plurality of available user devices, according to various embodiments.

FIG. 4 illustrates a swim lane diagram showing the process of handling a user request and dynamically selecting an appropriate device for invoking a user interface on the selected device, according to various embodiments.

FIG. 5 illustrates generally an example of a block diagram of a machine upon which any one or more of the techniques discussed herein can perform, in accordance with some embodiments.

### DETAILED DESCRIPTION

The increasing complexity and diversity of communication channels have presented opportunities to provide different workflows or to enhance user experiences across various fields. However, problems can arise when tools or information are fragmented across different devices or platforms, leading to disjointed interactions and decreased productivity. The reliance on external resources and a lack of a centralized, context-aware platform can further hinder the ability of a user to access critical information and make timely, informed decisions.

To address these issues, a multi-modal agent with a single session context across communication channels (e.g., communication channels) to multi-modal device control can be used. The multi-modal agent merges communications from multiple devices to produce a sequence of actions across devices to complete a task for a user. The actions in the sequence of actions can be targeted to a specific user device based on device capability, availability, or other factors maintained in the session context. The multi-modal agent can be implemented using a transformer architecture trained as a large language model (LLM). An LLM is a type of artificial intelligence trained on a massive dataset of text and code. The LLM can generate text, translate languages, write various kinds of creative content, and answer questions in generally accurate (depending upon training) and intuitive way. The multi-modal agent LLM is configured to produce the sequence of actions taking into account the session contest, enabling a new, cross device user interface to simplify multi-modal communication channels for users.

For example, consider a situation in which a social worker is walking into a hospital to help an orphaned child find a place to stay. Using the multi-modal agent, the social worker can audibly request a summary of the child's life to prepare for the meeting. The content of the request is placed into the session context and the multi-modal agent is configured to perform a search based on the session context to retrieve the file of the child. The session context indicates that the social worker is on their phone, but the detailed information of the file is impractical to consume either by voice or on the small screen of the phone. Thus, the multi-modal agent is configured to develop an action sequence that summarizes the material of the file and transmits the summary to the phone. The session context also indicates that the social worker has a laptop computer with a screen sufficient to convey the detailed information of the file. Thus, a second action in the sequence of actions includes transmitting the complete file to the laptop when the laptop is able to communicate (e.g., is no longer in sleep mode). In this manner, the multi-modal agent provides multi-modal (device and communication channels) communication to the user based on the session context via a sequence of actions created to complete a task. Additional details and examples are given below.

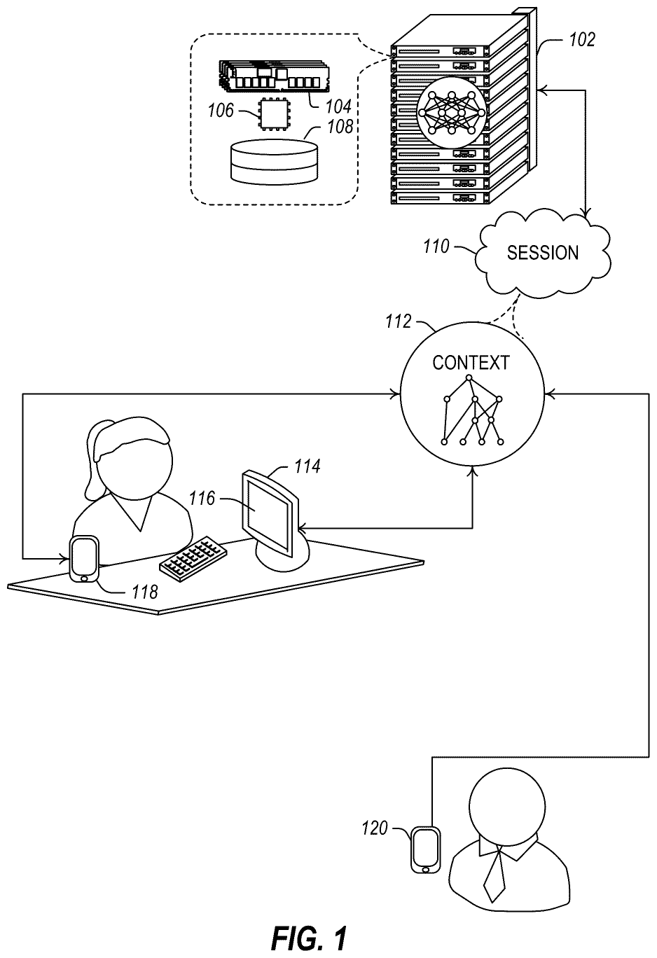

FIG. 1 illustrates an environment including a system 102 to implement a multi-modal agent, according to various embodiments. The system 102 includes storage 108 (e.g., non-volatile disc or solid-state storage), processing circuitry 106, and memory 104 (e.g., volatile memory to hold a working state of the system 102). The memory 104 can be differentiated by the storage 108 based on used. Typically, the memory 104 is used to store a current state of the system 102, is fast in comparison to the storage 108, and is not persistent between resets (e.g., power-off) of the system 102. In contrast, the storage 108 is persistent between resets and configured to hold data beyond the running state of the system. However, in operation, it is typical for the data from the storage 108 to be transferred to the memory 104 for use by the processing circuitry 106. As illustrated, the system 102 is connected via a network to a desktop computer 114, a mobile phone 118, and a mobile phone 120. In an example, the network connection can include a wired connection, such as an Ethernet connection, or a wireless connection, such as Wi-Fi, a cellular protocol, Bluetooth, or the like. A secure communication protocol can employ encryption algorithms such as Transport Layer Security (TLS) or Secure Sockets Layer (SSL) to protect the data transmitted between the user devices 114, 118, 120 and the system 102. In other examples, message authentication codes (MACs) or digital signatures can be used to ensure the integrity of the data.

The session 110 represents a logical boundary in a communication between a user and the multi-model agent. Aspects of the session 110 can include data representing a state of the session, connection characteristics (e.g., including session start and termination), participating entities, authentication of security parameters, etc. The session state can be stored in one or more data structures managed by the system 102, in cloud storage, or elsewhere. In an example, the session 110 can be governed by a session ID that serves to identify session-specific resources. For example, each user session can be uniquely identified by a session ID which serves as a key to access or manage the corresponding session-specific resources or state, such as the context 112.

The context 112 is specific to the multi-model agent rather than referring to general concept of a context. The context 112 is session state information and thus can be stored along with other session state information in the manner described above. The context 112 contains information specific to interactions with a user for a session—such as a history of user actions, the devices the user has used, or the location of the user or the devices, etc.—and is configured to be consumable by the multi-modal agent. For example, in the case of a social worker on their way to a hospital to help an orphaned child find a temporary home and requesting a summary of the child's life to prepare for the meeting, the context 112 can store the details of the ongoing interaction. These details can include a social worker's request for the child's file (e.g., a verbal or written request to the agent) or their current location (e.g., on their way to the hospital). In an example, the context 112 can implemented as a static or dynamic data structure that is created when the session 110 is created and includes or references the session ID. In an example, the context 112 can be dynamically updated throughout the session 110 as the user interacts with the system (e.g., real-time). In an example, the context 112 can be updated at specific predetermined intervals or after certain triggers.

In an example, for an LLM based multi-modal agent, the context is entirely provided to the LLM as input, along with a current prompt (e.g., user query) to produce output. The context 112 is configured to be the only context for the multi-modal agent with respect to the session 110 and the context 112 is singular without regard to the device involved in completion of a task or communication. Thus, there are not separate sessions or contexts used for communicating to the desktop computer 114 and the mobile phone 118.

In operation it is likely that state information for the session 110 is maintained by the system 102 (e.g., in the storage 108 or the memory 104). However, shared data repositories can also be used. Thus, in an example, the session 110 and thus the context 112 can be transmitted from the system 102 to one or more of the user devices 114, 118, 120 or vice versa.

The multi-modal agent can be implemented in various ways to offer flexibility in deployment or integration. In an example, the multi-modal agent can be implemented as a standalone application, providing a dedicated user interface for interaction by a user. In an example, the multi-modal agent can be implemented as a collection of micro services, each responsible for specific tasks such as natural language processing, device capability assessment, or context management. In an example, the multi-modal agent can be integrated within a larger software architecture, working in conjunction with other systems or services. The following examples illustrate an implementation by the processing circuitry 106 of the system 102.

The processing circuitry 106 is configured to use information within the context 112 to orchestrate the user devices (e.g., the desktop computer 114, the mobile phone 118, or the mobile phone 120) to complete tasks or information delivery. For example, the multi-modal agent can obtain (e.g., retrieve or receive), via a user interface 116, a request from the user, such as the social worker described above. The request corresponds to the session 110 that contains the context 112. As noted above, the context 112 includes information about the interactions with the user. For example, the request can be a prompt entered into a user interface, such as a chat interface on a mobile phone 118. For the social worker, this prompt can include an audible or a written request for a file summary for the child at issue. In an example, the interface can be presented on a plurality of user devices, including a desktop computer 114, a mobile phone 120, tablet, a smart speaker, etc.

In response to the social worker's request, the processing circuitry 106 is configured to invoke a large language model (LLM) to process the request and the context 112 to produce a sequence of actions to complete the request. As noted above, an LLM is an AI model that has a transformer architecture and is trained on large sources of information. Generally, an LLM is trained to produce a next most probable token given a sequence of tokens that are the context 112. Thus, given a context of “The only thing we have to fear is fear,” an LLM is likely to produce “itself” as the next token given the likely training data used to create the LLM. Thus, in practice, invoking the LLM involves adding the request to the context 112 and then providing the context 112 as input to the LLM to produce the resultant sequence of actions. Usually, each new token generated by the LLM is added to the context 112 and the context 112 is fed back through the LLM. This behavior ensures that the next produced token (e.g., the tokens making a second action in the sequence of actions) are probabilistically consistent with the last generated tokens as well as the contextual information (e.g., the rest of the context 112).

Training the multi-modal agent typically involves a large corpus of input text. Because of the probabilistic nature of typical LLM training, the text itself provides the correction information, as the LLM attempts to predict the next most likely token and then verifies that prediction against the additional text yet to be processed. This technique leads to surprising intuitive results in a general language case. However, to provide the action sequence to orchestrate the user devices, a technique often called few-shot learning is layered on top of the general LLM model to model specific output formats. Here, the LLM model is provide with a prompt and a specific output format and trained to conform the output to this format. Few-shot training over an existing general LLM produces accurate results in constrained formats, such as the sequence of actions. Although other techniques, including other AI models, can be used, the tailored LLM provides a sophisticated mechanism to enable the system 102 to interact with human users.

In an example, the sequence of actions can include accessing an external data source—such as a database, an application programming interface (API), or another external service—to retrieve information or perform specific tasks related to the user request. For example, the processing circuitry 106 (e.g., via the LLM) can process the social worker's request for the child's file and, using the context 112 (e.g., knowing the social worker is on their phone and that they have access to various other devices), generate a sequence of actions that includes retrieving the file from the database (e.g., in the storage 108 or elsewhere) and preparing a summarized version of the information suitable for the social worker's mobile device 118.

As noted above, the context 112 generally includes the complete interaction with the user. Thus, the context 112 can include a history of actions completed. This historical information can be used to guide future actions in the sequence based on user preference, or evolving circumstances, to provide more relevant responses or actions. For example, the context 112 can include a history of user devices used, user devices currently available, or user devices which will become available at a future time (e.g., based on a schedule for the user, the device, etc.). This information can be used to identify preferred devices for the user or to adapt the interface used or content to the specific device. In an example, the context 112 can include a listing of a user location. This information can be used to provide location-based services or to personalize the user experience based on the user's geographic context. For example, the social worker's present location can be used to determine which user devices are presently available to the social worker at the time of the request to prioritize fulfilling the request on those devices.

In an example, based on the context 112 (e.g., including capabilities of user devices), the processing circuitry 106 is configured to create actions in the sequence of actions to route tasks or information to these devices. For example, if a user initiates a complex data analysis task on their mobile phone 118, the processing circuitry 106 is configured to recognize a limited screen size of the mobile phone 118 and transfer the task to the desktop computer 114 for rendering on a larger display with greater processing power. This production of the sequence of actions can route complex information to devices with user interfaces that enable better consumption of that information or can transform the information for consumption on an available device.

For example, following the social worker use case noted above, the processing circuitry 106 is configured to produce a sequence of actions that, retrieve the case file for the child, recognize the limited format of the mobile phone 118, creates a summary of the case file for consumption on the mobile phone 118, and delivers the summary to the mobile phone 118. In an example, the sequence of actions can further include identifying that the desktop computer 114 is available later for use by the social worker and provide the full case file to the desktop computer for consumption on the user interface 116.

In an example, a physician can us the mobile phone 120 to check a patient's medical history before an upcoming appointment. In this example, the physician can make a request by voice to the multi-modal agent asking for a summary of the patient's recent lab results. In response to the voice request, the processing circuitry 106 is configured to create an action to retrieve the relevant data from a database. However, instead of overwhelming the physician with a lengthy and detailed report on the small screen of the mobile phone 120, the processing circuitry is configured to recognize (e.g., via a predefined screen size to information size comparison, or other constraints) the situation and create an action to transform the data into a concise audio summary highlighting any critical findings or abnormalities. This audio summary is transmitted by another action back to the mobile phone 118 of the physician. In an example, the physician's location or situational conditions (e.g., in a public space having lunch) can result in a situation inappropriate for divulging confidential information. In this example, the processing circuitry 106 is configured to create an action that specifies a delivery mechanism (e.g., text not voice) that preserves the patient's confidences.

In an example, the processing circuitry 106 is configured to select a first action from a list of possible actions and a device to carry out the first action. This selection can depend on factors such as the specific user request, the context 112, the capabilities of the available devices, or a combination thereof. In an example, if the request involves an action requiring voice input, the processing circuitry 106 is configured to select a first action involving voice input and direct the first action to be carried out on a device with a microphone. For example, the first action can be to deliver a summarized version of a child's file to the social worker via one of a plurality of available devices, and the mobile phone 118 can be selected as the first user device due to its portability and noting that the social worker is not at a desk. In an example, if the first action involves displaying a large image or a large amount of data, the processing circuitry 106 is configured to routing the action to a device with a large screen, such as the desktop computer 114 or a tablet.

In an example, the first action can include an interaction factor, or a specific requirement or characteristic of the interaction that is needed to complete the action successfully. The interaction factor can encompass the type of input required from the user (e.g., touch input for navigating a visual interface, keyboard input for typing a response, or voice input for hands-free operation), the desired format in which the information or results should be presented to the user (e.g., text, images, videos, or other interactive elements), or the level of computational effort required to complete the action (e.g., processing power or available resources). In an example, the processing circuitry 106 is configured to evaluate one or more of these interaction factors in conjunction with the capabilities of the available user devices to select the most suitable devices for executing the first action. Here, most suitable refers to a capability of one device being higher than a second device for the interaction factor. For example, in the case of the social worker described above, the first action identified by the multi-modal agent can be to “provide a concise audio summary of the child's file.” In this example, the interaction factors can include voice input, audio output to accommodate the social worker's present location of being away from their desk, and a moderate task complexity. Because the mobile phone 118 is present with the social worker, and the desktop computer 114 is not, the mobile phone 118 has a higher score on the interaction factor and thus is the more suitable device.

In an example, a first action can include a large format graphical representation of data. If the first user device can include a display in excess of twenty inches. Or other measure than matches a configuration for large format graphical data, the first action can be executed on the first device in order to complete the action. However, if the first device is off, or out or wireless contact, or has a smaller display, then the processing circuitry 106 is configured to register that the first device is unavailable with respect to completing the first action. The capabilities of different user devices through pre-defined specifications, real-time monitoring, or a combination thereof. Pre-defined specifications can include information about the device's screen size, processing power, available input or output mechanisms, or network connectivity. Real-time monitoring can involve tracking the device's current status, such as battery level, network signal strength, available resources, or location, to ensure that the selected device is capable of handling the assigned task effectively.

The processing circuitry 106 is configured to obtain an indication that the first user device is not available. The indication can be received from the user device itself, from another device or service, or from the user directly. In an example, the indication that the user device is not available can originate from a user selection of an alternative user device in response to a presentation of the first action to the user. For example, a conversational interface is configured to present a list of available devices to the user, and the user can select an alternative device. In an example, the device itself can send a signal to the multi-modal agent indicating its unavailability (e.g., due to being powered off or out of network coverage).

If the selected device (e.g., the first user device for the first action) is unavailable, the processing circuitry 106 is configured to select a second action that is different from the first action from the set of available actions. This second action is expected to perform better on a second device that is available. The selection of the second action can be based on the availability or unavailability of the first user device or the second user device, the original request, or the context 112 with a goal (e.g., performance indicator) that the user request is effectively completed. For example, consider the scenario in which the mobile phone 118 the social worker is selected to deliver a concise audio summary of the child's file as the first action. As the social worker is walking to the hospital or parking in a garage with poor network connection, they can encounter poor network connectivity, making it difficult to stream the audio summary to the mobile phone 118. In this example, the mobile phone 118 can send an indication of its unavailability and the processing circuitry 106 is configured to select a second action (e.g., a low-throughput text to the mobile phone 118) or a second device on which to invoke the second action.

In an example, the social worker, recognizing the limitations of listening to a detailed or confidential summary in a noisy environment (e.g., a need for privacy), can explicitly request the information be sent to their desktop computer instead. This is another form of unavailability for the first user device. In response to this indication, the processing circuitry 106 is configured to present the user with a list of available devices, enabling the user to select an alternative device.

In an example, the second user action can include a summary of the data for a screen smaller than twenty inches. In an example, the second user device can be selected based on its display size, with a preference for devices with larger displays (e.g., a desktop computer or a tablet) to provide a better viewing experience for the user. For example, consider a doctor on their lunch break using their mobile phone 120 to quickly check on a patient's most recent lab results. In response to the doctor's request, the multi-modal agent can provide a brief overview of the results on the mobile phone 120 which highlights any critical values and proactively send the complete lab report to the doctor's tablet or desktop computer 114 to ensure it is readily available for later viewing when they return to their workstation. In an example, the user device is not used by the user making the request but by another user. For example, if the user working at the desktop computer 114 would like a physical signature, but does not have a touch-capable device handy, the second action can be a request for a signature sent to another person on mobile phone 120 (or a tablet of this user) to bring the device to capture the signature. In this manner, although the task is prompted by the first user, additional users can be marshalled to complete the task. Other actions by the second user can include a request to lookup data in a secure system, printing data to paper or other media, or making a telephone phone call on behalf of the first user, among others.

In an example, the second action can include a second interaction factor. As noted above, interaction factors are metrics enabling a comparison between the availability and capability of a device and an action. As noted above, large format data doesn't display well on small screens, and this can be determined via the interaction factors. Stacking the interaction factors enables differing checks to be made when searching for user devices to which an action is directed. Accordingly, the second user device is selected amongst available user devices based on a greater score (e.g., match) the second interaction factor other user devices. For example, if the first action required a large display and the first user device was unavailable, the second user device can be selected because it also has a large display. However, if a similarly convenient large display user device is unavailable, then the second action can be adapted (different interaction factor(s) applied) for a smaller display. In an example, the interaction factor can be the size of a display. In an example, the second interaction factor can be a type of input, such as touch, keyboard, or voice. The processing circuitry 106 is configured to select a user device based on its ability to support the required input method for a particular action.

Invocation of the second action can include sending a notification or a message to the second user device, or launching an application or a specific function on the second user device. For example, once the social worker reaches their destination and the desktop computer 114 is available, the processing circuitry 106 is configured to detect the change in the context 112 and initiate the second action of transmitting the full client file to the laptop or desktop computer 114 for review. This seamless handover of between user devices based on the context 112 ensures that the user can fully leverage multiple modes of interaction over multiple communications channels.

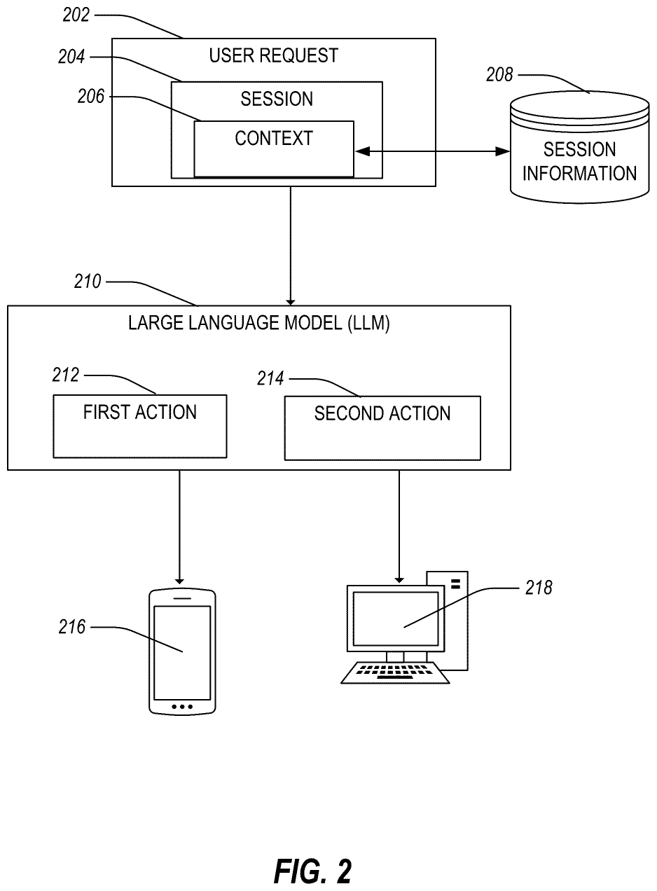

FIG. 2 illustrates an example of a technique for selecting a user device from a plurality of user devices based on a first action and the context, according to various embodiments. In the illustrated example, a user request 202, associated with a session 204, is received. The session 204 maintains information 208 about the session that include a context 206 that includes information about the interaction between the user and the multi-modal agent, such as the user's history, device preferences, or current location. This information is used by the multi-modal agent to make consistent decisions about task routing or device selection based on current circumstances of the user and user devices. For example, the context 206 can include past actions and interactions within the session 204 or across previous sessions, which enable the multi-modal agent to base decisions on user preferences or typical workflows. The context 206 can include information about preferred devices of the user for a one or more tasks. In an example, this preference can be configured through explicit settings or inferred from past behavior.

In an example, the session 204 is identified by a session ID that serves as a unique identifier for each session 204. The session ID can enable the multi-modal agent to manage and retrieve session-specific resources, such as the context 206. In an example, the context 206 can include a data structure that is created when the session 204 is created and includes or reference the session ID. In an example, the context 206 includes the user's physical location. This can influence device selection based on factors such as network availability or the suitability of devices for specific environments.

In an example, the user request 202 and the context 206 are provided as input to an LLM 210. The LLM is configured (e.g., trained) to accept this input and to generate a sequence of actions aimed at fulfilling the user request 202 as output. The LLM 210 is configured to select a first action 212 from the sequence of actions (predetermined acceptable actions in a workflow to respond to the request). The first action is evaluated in conjunction with the context 206 to determine the optimal (e.g., highest scoring on interaction factor(s)) user device (e.g., a mobile phone 216 or desktop computer 218) for execution. The selection of the optimal user device can be based on a variety of factors, such as the capabilities of the device, the nature of the first action 212, or the user's preferences as reflected in the context 206. For example, the first action might be best suited for a mobile device due to its portability or the need for immediate access, leading to the selection of a mobile device (e.g., the mobile phone 216) for execution of the first action 212.

In an example, an indication that the initially selected device is unavailable is obtained. This unavailability may be the result of various factors. For example, the first device could be turned off, out of network range, or simply not in the immediate vicinity of the user. In this case, the situation is revaluated based on the user request 202 and the context 206 after being updated with the unavailability of the first user device, to select a second action 214 that can still effectively address the user request 202. The system can then proceed to select a second user device (e.g., the desktop computer 218) that is best suited for the second action 214. However, the contra example can also exist, whereby the second user device is selected based on the availability of the second user device and the second action is an adaptation of the first action to function well on the second user device. For example, the second action 214 can require a larger screen or more robust processing capabilities, prompting the system to select the desktop computer 218. The selection of the second user device can be based on similar factors as the selection of the first user device, but with additional consideration of the unavailability of the first user device, the nature of the second action, or a combination thereof. An interface can then be invoked on the second user device to perform the second action 214.

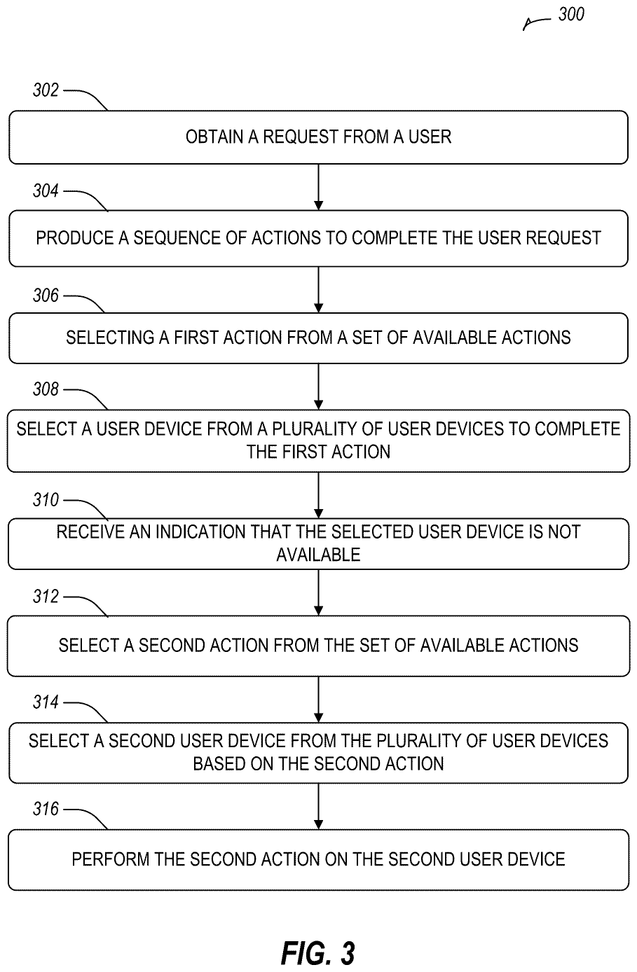

FIG. 3 illustrates a flowchart showing a technique 300 for dynamically selecting a user device to execute an action from a plurality of available user devices, according to various embodiments. In an example, operations of the technique 300 can be performed by processing circuitry, for example, by executing instructions stored in memory. The processing circuitry can include a processor, a system on a chip, or other circuitry (e.g., wiring). For example, the technique 300 can be performed by processing circuitry of a device (or one or more hardware or software components thereof), such as those illustrated or described with reference to FIG. 1.

At operation 302, a request from a user is obtained (e.g., retrieve or receive via an interface). This request corresponds to a session with a context. In an example, the context includes a history of actions completed. In an example, the context includes a history of user devices used. In an example, the context can include a listing of user locations. In an example, the request is a prompt entered into a conversational interface. In an example, the interface upon which the request was received was presented on a plurality of user devices. In an example, the plurality of user devices includes a computer, a smartphone, or a tablet.

At operation 304, a large language model (LLM) is invoked on the request and the context to produce a sequence of actions to complete the request. In an example, the LLM is a pre-trained language model that is fine-tuned (e.g., few-shot training) on a specific domain or task. In an example, the LLM is a general-purpose language model configured to understand and respond to a wide range of requests. In an example, the sequence of actions can include one or more actions to access an external data source. In an example, the external data source is a database, an API, or web destination. In an example, the sequence of actions includes one or more actions to retrieve information or perform specific tasks from the external data source related to the user request.

At operation 306, a first action is selected, as next action, from a set of available actions for a position in the sequence of actions. In an example, the selection of the first action is based on a range of factors, such as the request, the context, or the capabilities of the available user devices. In an example, the first action can include an interaction factor, such as an input method (e.g., touch, keyboard, voice), an output format (e.g., text, image, video) or a complexity of the task. The first user device can be selected based on the ability of the first device to match the interaction factor to an equal or greater degree than other user devices in the plurality of user devices.

At operation 308, a user device can be selected from a plurality of user devices to complete the next action based on the first action and the context. The selection of the user device can consider several factors, such as the device's capabilities, the user's preferences, or the context of the session.

At operation 310, an indication that the user device is not available is receive. The indication can be received from the user device itself, from another device or service, or from the user directly. In an example, the indication that the user device is not available can originate from a user selection of an alternative user device in response to a presentation of the first action to the user. For example, the system can present a list of available devices to the user, and the user can select an alternative device if the initially selected device is not available or suitable.

At operation 312, a second action, for the next action, is selected from the set of available actions for the position in the sequence of actions based on the indication, the request, and the context. The selection of the second action can consider the unavailability of the first user device, the user's original request, and the context of the session to ensure that the user request is still executed effectively. For example, the first action can include a large format graphical representation of data that has a nominal viewing requirement of a display greater than or equal to twenty inches. If the first user device has a display less than twenty inches, the second action can include a summary of the data for a screen smaller than twenty inches.

At operation 314, a second user device selected be selected from the plurality of user devices based on the second action. The selection of the second user device can consider several factors, such as the device's capabilities, the user's preferences, or the context of the session, as well as the specific requirements of the second action. In an example, the second action can include a second interaction factor. The second user device can be selected based on an ability to match the second interaction factor to a greater degree than the first user device. For example, if the first action required a large display and the first user device was unavailable, the second device can be selected based on similarly large display. In an example, the interaction factor or the second interaction factor is a size of a display. In an example, the interaction factor can be a type of input. In an example, the type of input is touch, keyboard (e.g., or other button-based inputs), or voice.

At operation 316, an interface is invoked via the second user device to perform the second action. In an example, invoking the second action on the second device can include sending a notification or a message to the second user device or launching an application or a specific function on the second user device.

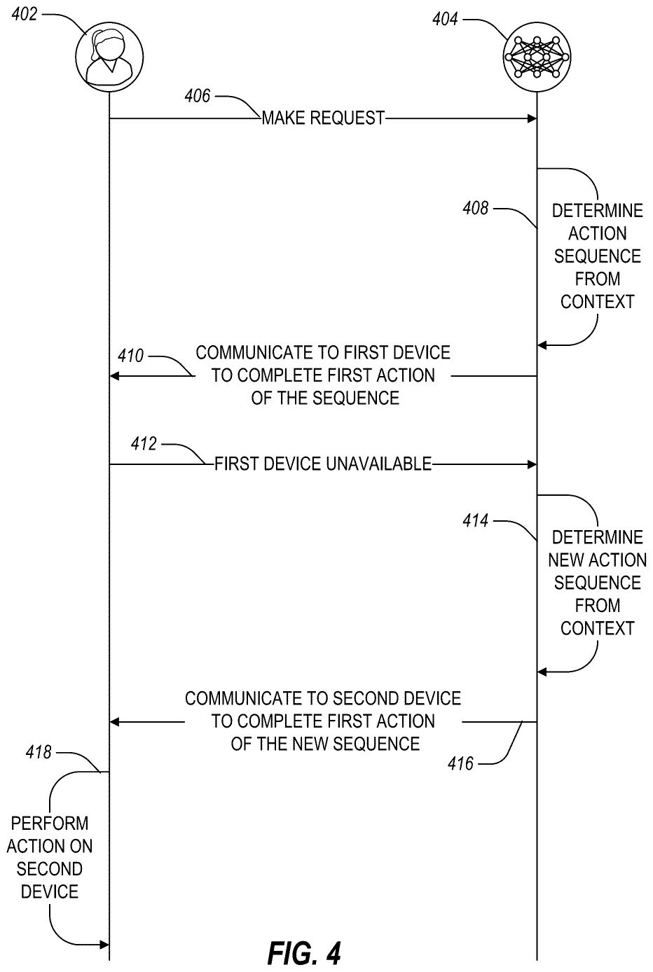

FIG. 4 illustrates a swim lane diagram showing the process of handling a user request and dynamically selecting an appropriate device for invoking a user interface on the selected device, according to various embodiments. The swim lane diagram includes two lanes, one for the user 402 and one for the multi-modal agent 404.

In an example, the user 402 can initiate a request (message 406). The multi-modal agent 404 can process the request and context to select a first action and select a first device for the first action (operation 408). The multi-model agent 404 then communicates the action to the first device (message 410). The multi-model agent 404 receives a response (message 412) that the first device is unavailable. The multi-modal agent 404 then selects a second action and a second device (operation 414) to fulfill the request (from message 406). The second action is then communicated to the second device (message 416) enabling the user 402 to perform the second action (operation 418) on the second device.

In an example, the user 402 can indicate that the first device is unavailable (message 412). In an example, the first action can be to display a graphical representation of data, and the first device can be unavailable because it has a display that is too small to adequately display the graphical representation of data. In response, the multi-modal agent 404 can select the second action (operation 414) to display a summary of the data on the first device or can select a second device with a larger display. In an example, the user 402 can initiate a request to transfer an ongoing task from one device to another. In response, the multi-modal agent 404 can identify an additional action to transfer the task and can select a second device to perform the action of transferring the task.

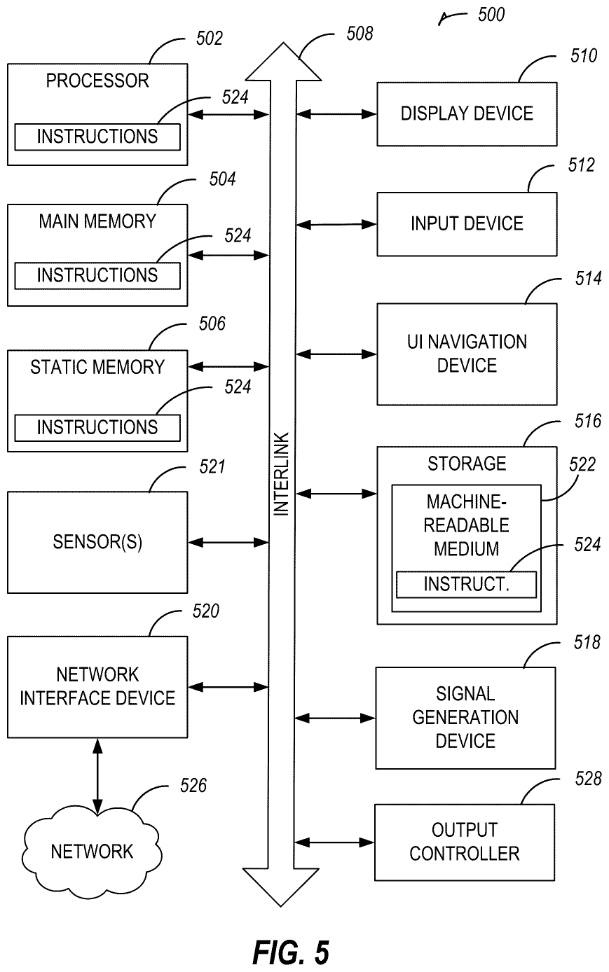

FIG. 5 illustrates generally an example of a block diagram of a machine upon which any one or more of the techniques discussed herein can perform, in accordance with some embodiments. In alternative embodiments, the machine 500 can operate as a standalone device or can be connected (e.g., networked) to other machines. In a networked deployment, the machine 500 can operate in the capacity of a server machine, a client machine, or both in server-client network environments. In an example, the machine 500 can act as a peer machine in peer-to-peer (P2P) (or other distributed) network environment. The machine 500 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, can include, or can operate on, logic or a number of components, modules, or mechanisms. Modules are tangible entities (e.g., hardware) capable of performing specified operations when operating. A module includes hardware. In an example, the hardware can be specifically configured to carry out a specific operation (e.g., hardwired). In an example, the hardware can include configurable execution units (e.g., transistors, circuits, etc.) or a computer readable medium containing instructions, where the instructions configure the execution units to carry out a specific operation when in operation. The configuring can occur under the direction of the executions units or a loading mechanism. Accordingly, the execution units are communicatively coupled to the computer readable medium when the device is operating. In this example, the execution units can be a member of more than one module. For example, under operation, the execution units can be configured by a first set of instructions to implement a first module at one point in time or reconfigured by a second set of instructions to implement a second module.

Machine (e.g., computer system) 500 can include a hardware processor 502 (e.g., a central processing unit (CPU), a graphics processing unit (GPU), a hardware processor core, or any combination thereof), a main memory 504 or a static memory 506, some or all of which can communicate with each other via an interlink (e.g., bus) 508. The machine 500 can further include a display unit 510, an alphanumeric input device 512 (e.g., a keyboard), or a user interface (UI) navigation device 514 (e.g., a mouse). In an example, the display unit 510, alphanumeric input device 512 or UI navigation device 514 can be a touch screen display. The machine 500 can additionally include a storage device (e.g., drive unit) 516, a signal generation device 518 (e.g., a speaker), a network interface device 520, or one or more sensors 521, such as a global positioning system (GPS) sensor, compass, accelerometer, or other sensor. The machine 500 can include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 can include a machine readable medium 522 that is non-transitory on which is stored one or more sets of data structures or instructions 524 (e.g., software) embodying or utilized by any one or more of the techniques or functions described herein. The instructions 524 can reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 can constitute machine readable media.

While the machine readable medium 522 is illustrated as a single medium, the term “machine readable medium” can include a single medium or multiple media (e.g., a centralized or distributed database, or associated caches or servers) configured to store the one or more instructions 524.

The term “machine readable medium” can include any medium that is capable of storing, encoding, or carrying instructions for execution by the machine 500 or that cause the machine 500 to perform any one or more of the techniques of the present disclosure, or that is capable of storing, encoding or carrying data structures used by or associated with such instructions. Non-limiting machine-readable medium examples can include solid-state memories, or optical or magnetic media. Specific examples of machine-readable media can include: non-volatile memory, such as semiconductor memory devices (e.g., Electrically Programmable Read-Only Memory (EPROM), Electrically Erasable Programmable Read-Only Memory (EEPROM)) or flash memory devices; magnetic disks, such as internal hard disks or removable disks; magneto-optical disks; or CD-ROM or DVD-ROM disks.

The instructions 524 can further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), networks, or wireless data networks (e.g., Institute of Electrical or Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 can include one or more physical jacks (e.g., Ethernet, coaxial, or phone jacks) or one or more antennas to connect to the communications network 526. In an example, the network interface device 520 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, or includes digital or analog communications signals or other intangible medium to facilitate communication of such software.

The following, non-limiting examples, detail certain aspects of the present subject matter to solve the challenges or provide the benefits discussed herein, among others.

Example 1 is an apparatus comprising: a memory configured to store instructions; and processing circuitry that, when in operation, is configured by the instructions to: obtain a request from a user, the request corresponding to a session, the session having a context; invoke a large language model (LLM) on the request and the context to produce a sequence of actions to complete the request; select a first action, as next action, from a set of available actions for a position in the sequence of actions; select, based on the first action and the context, a first user device from a plurality of user devices to complete the next action; receive an indication that the first user device is not available; select a second action, for the next action, from the set of available actions for the position in the sequence of actions based on the indication, the request, and the context; select a second user device from the plurality of user devices based on the second action; and invoke, via the second user device, an interface to perform the second action.

In Example 2, the subject matter of Example 1, wherein the context includes a history of actions completed.

In Example 3, the subject matter of any of Examples 1-2, wherein the context includes a history of user devices used.

In Example 4, the subject matter of any of Examples 1-3, wherein the context includes a listing of user locations.

In Example 5, the subject matter of any of Examples 1-4, wherein the first action includes an interaction factor, and wherein the first user device matched the interaction factor to an equal or greater degree than other user devices in the plurality of user devices.

In Example 6, the subject matter of Example 5, wherein the second action includes a second interaction factor, and wherein the second user device matched the second interaction factor to a greater degree than the first user device.

In Example 7, the subject matter of any of Examples 5-6, wherein the interaction factor is a size of a display.

In Example 8, the subject matter of Example 7, wherein the first action includes a large format graphical representation of data, wherein the first user device includes a display in excess of twenty inches, wherein the second action includes a summary of the data for a screen smaller than twenty inches.

In Example 9, the subject matter of any of Examples 5-8, wherein the interaction factor was a type of input.

In Example 10, the subject matter of any of Examples 1-9, wherein the request is a prompt entered into a conversational interface.

In Example 11, the subject matter of any of Examples 1-10, wherein the sequence of actions includes accessing an external data source.

In Example 12, the subject matter of any of Examples 1-11, wherein the indication that the first user device is not available originates from a user selection of an alternative user device in response to a presentation of the first action to the user.

Example 13 is a method comprising: obtaining a request from a user, the request corresponding to a session, the session having a context; invoking a large language model (LLM) on the request and the context to produce a sequence of actions to complete the request; selecting a first action, as next action, from a set of available actions for a position in the sequence of actions; selecting, based on the first action and the context, a first user device from a plurality of user devices to complete the next action; receiving an indication that the first user device is not available; selecting a second action, for the next action, from the set of available actions for the position in the sequence of actions based on the indication, the request, and the context; selecting a second user device from the plurality of user devices based on the second action; and invoking, via the second user device, an interface to perform the second action.

In Example 14, the subject matter of Example 13, wherein the context includes a history of actions completed.

In Example 15, the subject matter of any of Examples 13-14, wherein the context includes a history of user devices used.

In Example 16, the subject matter of any of Examples 13-15, wherein the context includes a listing of user locations.

In Example 17, the subject matter of any of Examples 13-16, wherein the first action includes an interaction factor, and wherein the first user device matched the interaction factor to an equal or greater degree than other user devices in the plurality of user devices.

In Example 18, the subject matter of Example 17, wherein the second action includes a second interaction factor, and wherein the second user device matched the second interaction factor to a greater degree than the first user device.

In Example 19, the subject matter of any of Examples 17-18, wherein the interaction factor is a size of a display.

In Example 20, the subject matter of Example 19, wherein the first action includes a large format graphical representation of data, wherein the first user device includes a display in excess of twenty inches, wherein the second action includes a summary of the data for a screen smaller than twenty inches.

In Example 21, the subject matter of any of Examples 17-20, wherein the interaction factor was a type of input.

In Example 22, the subject matter of any of Examples 13-21, wherein the request is a prompt entered into a conversational interface.

In Example 23, the subject matter of any of Examples 13-22, wherein the sequence of actions includes accessing an external data source.

In Example 24, the subject matter of any of Examples 13-23, wherein the indication that the first user device is not available originates from a user selection of an alternative user device in response to a presentation of the first action to the user.

Example 25 is a machine readable medium including instructions that, when executed by processing circuitry, cause the processing circuitry to perform operations comprising: obtaining a request from a user, the request corresponding to a session, the session having a context; invoking a large language model (LLM) on the request and the context to produce a sequence of actions to complete the request; selecting a first action, as next action, from a set of available actions for a position in the sequence of actions; selecting, based on the first action and the context, a first user device from a plurality of user devices to complete the next action; receiving an indication that the first user device is not available; selecting a second action, for the next action, from the set of available actions for the position in the sequence of actions based on the indication, the request, and the context; selecting a second user device from the plurality of user devices based on the second action; and invoking, via the second user device, an interface to perform the second action.

In Example 26, the subject matter of Example 25, wherein the context includes a history of actions completed.

In Example 27, the subject matter of any of Examples 25-26, wherein the context includes a history of user devices used.

In Example 28, the subject matter of any of Examples 25-27, wherein the context includes a listing of user locations.

In Example 29, the subject matter of any of Examples 25-28, wherein the first action includes an interaction factor, and wherein the first user device matched the interaction factor to an equal or greater degree than other user devices in the plurality of user devices.

In Example 30, the subject matter of Example 29, wherein the second action includes a second interaction factor, and wherein the second user device matched the second interaction factor to a greater degree than the first user device.

In Example 31, the subject matter of any of Examples 29-30, wherein the interaction factor is a size of a display.

In Example 32, the subject matter of Example 31, wherein the first action includes a large format graphical representation of data, wherein the first user device includes a display in excess of twenty inches, wherein the second action includes a summary of the data for a screen smaller than twenty inches.

In Example 33, the subject matter of any of Examples 29-32, wherein the interaction factor was a type of input.

In Example 34, the subject matter of any of Examples 25-33, wherein the request is a prompt entered into a conversational interface.

In Example 35, the subject matter of any of Examples 25-34, wherein the sequence of actions includes accessing an external data source.

In Example 36, the subject matter of any of Examples 25-35, wherein the indication that the first user device is not available originates from a user selection of an alternative user device in response to a presentation of the first action to the user.

Example 37 is a system comprising: means for obtaining a request from a user, the request corresponding to a session, the session having a context; means for invoking a large language model (LLM) on the request and the context to produce a sequence of actions to complete the request; means for selecting a first action, as next action, from a set of available actions for a position in the sequence of actions; means for selecting, based on the first action and the context, a first user device from a plurality of user devices to complete the next action; means for receiving an indication that the first user device is not available; means for selecting a second action, for the next action, from the set of available actions for the position in the sequence of actions based on the indication, the request, and the context; means for selecting a second user device from the plurality of user devices based on the second action; and means for invoking, via the second user device, an interface to perform the second action.

In Example 38, the subject matter of Example 37, wherein the context includes a history of actions completed.

In Example 39, the subject matter of any of Examples 37-38, wherein the context includes a history of user devices used.

In Example 40, the subject matter of any of Examples 37-39, wherein the context includes a listing of user locations.

In Example 41, the subject matter of any of Examples 37-40, wherein the first action includes an interaction factor, and wherein the first user device matched the interaction factor to an equal or greater degree than other user devices in the plurality of user devices.

In Example 42, the subject matter of Example 41, wherein the second action includes a second interaction factor, and wherein the second user device matched the second interaction factor to a greater degree than the first user device.

In Example 43, the subject matter of any of Examples 41-42, wherein the interaction factor is a size of a display.

In Example 44, the subject matter of Example 43, wherein the first action includes a large format graphical representation of data, wherein the first user device includes a display in excess of twenty inches, wherein the second action includes a summary of the data for a screen smaller than twenty inches.

In Example 45, the subject matter of any of Examples 41-44, wherein the interaction factor was a type of input.

In Example 46, the subject matter of any of Examples 37-45, wherein the request is a prompt entered into a conversational interface.

In Example 47, the subject matter of any of Examples 37-46, wherein the sequence of actions includes accessing an external data source.

In Example 48, the subject matter of any of Examples 37-47, wherein the indication that the first user device is not available originates from a user selection of an alternative user device in response to a presentation of the first action to the user.

PNUM Example 49 is at least one machine-readable medium including instructions that, when executed by processing circuitry, cause the processing circuitry to perform operations to implement of any of Examples 1-48.

PNUM Example 50 is an apparatus comprising means to implement of any of Examples 1-48.

PNUM Example 51 is a system to implement of any of Examples 1-48.

PNUM Example 52 is a method to implement of any of Examples 1-48.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code can form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks or digital video disks), magnetic cassettes, memory cards or sticks, random access memories (RAMs), read only memories (ROMs), or the like.

What is claimed is:

1. An apparatus comprising:
a memory configured to store instructions; and
processing circuitry that, when in operation, is configured by the instructions to:
obtain a request from a user, the request corresponding to a session, the session having a context;
invoke a large language model (LLM) on the request and the context to produce a sequence of actions to complete the request;
select a first action, as next action, from a set of available actions for a position in the sequence of actions;
select, based on the first action and the context, a first user device from a plurality of user devices to complete the next action;
receive an indication that the first user device is not available;
select a second action, for the next action, from the set of available actions for the position in the sequence of actions based on the indication, the request, and the context;
select a second user device from the plurality of user devices based on the second action; and
invoke, via the second user device, an interface to perform the second action.

2. The apparatus of claim 1, wherein the context includes a history of actions completed.

3. The apparatus of claim 1, wherein the context includes a history of user devices used.

4. The apparatus of claim 1, wherein the first action includes an interaction factor, and wherein the first user device matched the interaction factor to an equal or greater degree than other user devices in the plurality of user devices.

5. The apparatus of claim 4, wherein the second action includes a second interaction factor, and wherein the second user device matched the second interaction factor to a greater degree than the first user device.

6. The apparatus of claim 4, wherein the interaction factor is a size of a display.

7. The apparatus of claim 4, wherein the interaction factor was a type of input.

8. The apparatus of claim 1, wherein the indication that the first user device is not available originates from a user selection of an alternative user device in response to a presentation of the first action to the user.

9. A machine readable medium including instructions that, when executed by processing circuitry, cause the processing circuitry to perform operations comprising:
obtaining a request from a user, the request corresponding to a session, the session having a context;
invoking a large language model (LLM) on the request and the context to produce a sequence of actions to complete the request;
selecting a first action, as next action, from a set of available actions for a position in the sequence of actions;
selecting, based on the first action and the context, a first user device from a plurality of user devices to complete the next action;
receiving an indication that the first user device is not available;
selecting a second action, for the next action, from the set of available actions for the position in the sequence of actions based on the indication, the request, and the context;
selecting a second user device from the plurality of user devices based on the second action; and
invoking, via the second user device, an interface to perform the second action.

10. The machine readable medium of claim 9, wherein the context includes a history of actions completed.

11. The machine readable medium of claim 9, wherein the context includes a history of user devices used.

12. The machine readable medium of claim 9, wherein the context includes a listing of user locations.

13. The machine readable medium of claim 9, wherein the first action includes an interaction factor, and wherein the first user device matched the interaction factor to an equal or greater degree than other user devices in the plurality of user devices.

14. The machine readable medium of claim 13, wherein the second action includes a second interaction factor, and wherein the second user device matched the second interaction factor to a greater degree than the first user device.

15. The machine readable medium of claim 13, wherein the interaction factor is a size of a display.

16. The machine readable medium of claim 15, wherein the first action includes a large format graphical representation of data, wherein the first user device includes a display in excess of twenty inches, wherein the second action includes a summary of the data for a screen smaller than twenty inches.

17. The machine readable medium of claim 13, wherein the interaction factor was a type of input.

18. The machine readable medium of claim 9, wherein the request is a prompt entered into a conversational interface.

19. The machine readable medium of claim 9, wherein the sequence of actions includes accessing an external data source.

20. The machine readable medium of claim 9, wherein the indication that the first user device is not available originates from a user selection of an alternative user device in response to a presentation of the first action to the user.
